(19) United States
(12) Patent Application Publication
(10) Pub. No.: US 2011/0200871 A1
(43) Pub. Date: Aug. 18, 2011

(54) ELECTROCHEMICAL CELL AND PROCESS FOR PRODUCING IT

(75) Inventors: Eduard Pytlik, Ellwangen (DE); Martin Krebs, Rosenberg (DE)

(73) Assignee: VARTA MICROBATTERY GMBH, Hannover (DE)

(21) Appl. No.: 12/934,475

(22) PCT Filed: Apr. 1, 2009
(86) PCT No.: PCT/EP2009/002364

§ 371 Date: Nov. 30, 2010

(30) Foreign Application Priority Data
Apr. 3, 2008 (DE) 10 2008 018 172.2

(51) Int. Cl. H01M 2/08; H01M 6/00

(52) U.S. Cl. 429/185; 29/623.2

(57) ABSTRACT

A process for producing an electrochemical cell includes assembling a cell housing from a plurality of parts, and applying and curing at least one reactive polymer precursor to at least one of the housing parts to seal the housing.

### TECHNICAL FIELD

This is a §371 of International Application No. PCT/EP2009/002364, with an international filing date of Apr. 1, 2009, which is based on German Patent Application No. 102008018172.2 filed Apr. 3, 2008, the subject matter of which is incorporated by reference.

This disclosure relates to a process for producing an electrochemical cell, a cell which can be produced by the process and the use of defined polymers as sealing material for electrochemical cells.

### BACKGROUND

Electrochemical cells, in particular those in button cell form, generally have a cell cup and a cell lid. The cell cup can, for example, be produced from nickel-plated deep-drawn metal sheet as punch-drawn part. The cell cup usually forms the positive pole and the cell lid forms the negative pole. Such button cells can contain a wide variety of electrochemical systems, for example nickel/cadmium, nickel/metal hydride, zinc/MnO₂ or primary and secondary lithium systems.

The liquid-tight closure of such cells is generally effected by crimping the edge of the cell cup over the cell lid. A plastic ring arranged between cell cup and cell lid generally simultaneously serves as seal and insulates the cell cup from the cell lid. Such button cells are known, for example, from DE 3113309.

The sealing elements required for these button cells are classically produced by injection molding, for example, from polyamides. The injection molding tools required for this purpose are very complicated and expensive. In addition, it is virtually impossible to produce sealing elements having wall thicknesses of less than 0.3 mm by injection molding, so that the known seals take up, particularly in the case of very small button cells, a comparatively large volume and thus adversely affect the capacity utilization of the cell.

DE 196 47 593 discloses a sealing element produced from a film by deep drawing. A cup-shaped molding is drawn from a heated film by a drawing die and a molding punch under reduced pressure. An opening is subsequently punched out by a cutting punch and a cutting sleeve in the bottom region of the cup-shaped molding produced by deep drawing. The sealing element produced is mounted on a cell lid which can then be placed in a cell cup. Depending on the process parameters selected, sealing elements having wall thicknesses in the range from 0.1 mm to 0.3 mm can be produced by that process.

A button cell having such a sealing element made of a film accordingly offers significant advantages in terms of the achievable capacity utilization compared to button cells having seals made of injection-molded parts. Nevertheless, further optimization of the internal volume of the cells available for active material continues to be elusive in the production of electrochemical cells.

### SUMMARY

We provide a process for producing an electrochemical cell comprising assembling a cell housing from a plurality of parts, and applying and curing at least one reactive polymer precursor to at least one of the housing parts to seal the housing.

We also provide an electrochemical cell comprising an at least two-part housing made up of a cell cup and a cell lid produced by a process wherein the housing is sealed by an electrically nonconductive polymer film.

### BRIEF DESCRIPTION OF THE FIGURE

FIG. 1 schematically illustrates the production of a button cell.

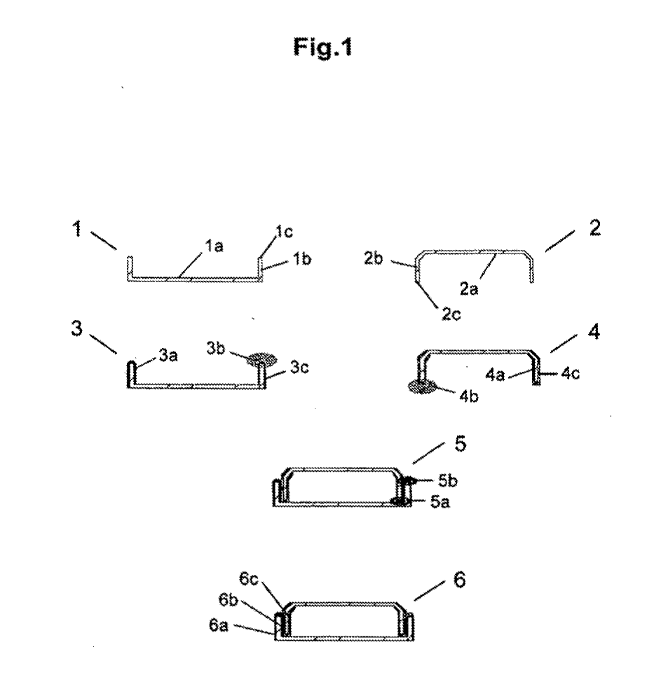

### DETAILED DESCRIPTION

Our process serves to produce electrochemical cells, in particular button cells. A cell housing is assembled from a plurality of parts, with at least one reactive polymer precursor applied to and cured on at least one of the housing parts to seal the housing.

The term “polymer precursor” refers to all one-component and multicomponent systems from which compounds having a polymeric structure can be produced. The at least one polymer precursor can have both reactive individual monomers and also precrosslinked monomer components. The at least one polymer precursor is preferably applied in liquid form, for example, as surface coating composition (see below), to the at least one housing part, but deposition from the gas phase is also possible, which will be discussed in more detail below.

In contrast to the prior art, separate components such as film seals or injection-molded seals are therefore no longer required according to our process for sealing an electrochemical cell. Instead, a polymer layer or coating which can effectively seal the cell housing is produced on one or more of the housing parts. This has obvious advantages. Thus, the complicated production of conventional sealing elements by injection molding or deep drawing processes can be dispensed with, as can the assembly of these in the production of electrochemical cells. In addition, the application and curing of the polymer precursor makes it possible to produce sealing layers or coatings whose thickness is only a fraction of the thickness of known sealing elements. In addition, the layer thickness can be set flexibly.

The at least one polymer precursor is particularly preferably applied to the at least one housing part in such a way that in the assembled housing it forms a layer in the contact region of the housing parts, in particular between the housing parts. In particular, it can be preferred that the at least one polymer precursor is applied in such a way that after curing it forms a layer in the assembled housing which insulates the parts of the housing from one another. The at least one polymer precursor is preferably selected so that it has, at least in the cured state, electrically insulating properties.

In addition, it is generally preferred that the at least one polymer precursor is in the cured state chemically inert toward conventional electrolytes, in particular toward aqueous alkaline electrolytes and/or organic electrolytes, in particular those based on carbonate. The process is suitable for producing electrochemical cells having a wide variety of electrochemical systems, in particular nickel/cadmium, zinc-air, NiMH and Li cells. These generally always comprise at least one positive electrode, at least one negative electrode, at least one separator and an electrolyte. The latter is chosen as a function of the electrochemical system.

Furthermore, it can be desirable for the at least one polymer precursor to have hydrophobic properties in the cured state. This can be utilized to counter corrosion problems in particularly critical regions of the cell housing, which will be discussed in more detail below.

With a view to the required curing of the at least one polymer precursor, it can be preferred that the at least one polymer precursor can be cured thermally and/or by radiation. Additives such as crosslinkers, photoinitiators, free-radical initiators, etc., can therefore be added to the polymer precursor. These additives are, in particular, additives known to those skilled in the art for adjusting and stabilizing the properties of surface coatings. Examples are photoinitiators such as α-hydroxyalkylphenones or acylphosphine oxides. The crosslinkers mentioned are generally selected as a function of the binder used. Suitable crosslinkers are known to those skilled in the art.

Preference is given to using precursors for organic polymers as polymer precursors. As mentioned briefly above, these can essentially be known surface coating systems such as surface coatings based on epoxide, polyester, polyacrylate and/or polyurethane, as long as these have, in the cured state, the abovementioned properties which may be necessary in an individual case (electrically insulating properties, chemical inertness toward conventional electrolytes, hydrophobic properties).

However, parylene precursors are particularly preferred as polymer precursors. Parylene is, as is known, an inert, hydrophobic, optically transparent, polymeric coating material having a wide range of industrial uses. Parylene is produced by chemical vapor deposition. The starting material is di-para-xylylene or a halogenated derivative thereof. This is vaporized and passed through a high-temperature zone. This forms a highly reactive monomer (the polymer precursor for the purposes of the present patent application) which generally immediately reacts on the surface of the substrate to be coated to form a chain-like polymer. To cure the polymer, it is merely necessary to maintain the substrate to be coated at a not too high temperature, for example room temperature. Parylene is preferably applied to a substrate under reduced pressure as a pore-free and transparent polymer film by condensation from the gas phase. Coating thicknesses of from 0.1 μm to 50 μm can be applied in one operation.

Preferably, a precursor for an inorganic-organic copolymer, in particular an ormocer precursor, can also be applied as polymer precursor.

Ormocers are, as is known, a relatively new class of composites which are described, for example, in DE 100 16 324. The name ORMOCER® is an acronym for “ORganically MOdified CERamics”. Ormocers are very suitable for influencing the surface properties of substrates of all types, for example of polymers, ceramic, glass, metal, paper and wood. Apart from increasing the mechanical and chemical resistance of the substrates, various additional functions can be produced on the surface. Ormocers are, inter alia, very suitable as barrier layer for gases, solvents and ions. Hydrophobic properties can also be set in a targeted manner.

These polymers reminiscent of silicones are produced by a sol-gel process in the presence of acidic or basic catalysts. Ormocers are accordingly inorganic-organic polymers. In the sol-gel process, an inorganic framework is first built up by controlled hydrolysis and condensation of organically modified Si alkoxides. Cocondensation with other metal alkoxides (e.g. Ti, Zr and Al alkoxides) is likewise possible. In a subsequent step, the polymerizable groups immobilized on the inorganic framework are crosslinked, for example thermally and/or with UV initiation. In addition, it is possible to use organically modified Si alkoxides which do not undergo any organic polymerization reactions and thus contribute to organic functionalization of the inorganic framework. This two-stage process builds up an inorganic/organic copolymer. This can be applied to a substrate by a conventional coating process (dipping or spraying processes, doctor blade application, spin-on processes, roller application or micro spray application) and can be cured on the substrate in a subsequent step.

Curing the at least one polymer precursor in the process is preferably carried out after assembly of the housing. However, it is also possible to precure the at least one polymer precursor on the at least one housing part before assembly and carry out final curing after assembly. Curing itself can be effected by radiation and/or thermally, as mentioned above. Thermal curing encompasses not only curing at temperatures above room temperature. In particular, it can also refer to allowing the at least one polymer precursor applied to stand at a particular temperature, in particular room temperature. This can apply, for example, when a parylene which in general can cure on its own at temperatures of <35° C. without further intervention is used as at least one polymer precursor.

The cell housing of an electrochemical cell is preferably assembled from metal parts, in particular parts made of nickel-plated steel or sheet metal. Further suitable metallic materials are, for example, trimetals, for example with the sequence nickel, steel (or stainless steel) and copper (from the outside inward).

The housing parts to be assembled are in preferred cases a cell cup and a cell lid, in particular in a process for producing button cells.

In these cases, particular preference is given to the at least one polymer precursor being applied to the cell cup and/or the cell lid in such a way that it covers the edge region of the cell cup and/or the cell lid.

The edge region of cell cups and cell lids can be particularly sensitive to corrosion. In the case of housing parts made of nickel-plated steel or of trimetal, the more corrosion-sensitive layers are open in this region (cut edge) and offer an excellent target for attack by corrosive media. This is prevented or countered by application of the at least one polymer precursor in this region. In the cured state, the at least one polymer precursor can then form a bifunctional layer which both has a sealing action and inhibits corrosion.

We likewise provide an electrochemical cell, in particular a button cell, which comprises an at least two-part housing. The two-part housing preferably comprises a cell cup and a cell lid. In particular, the electrochemical cell is characterized by the housing being sealed by an electrically nonconductive polymer film.

The polymer film is particularly preferably a coating on the surface of at least one of the housing parts. The polymer film is preferably joined firmly to the surface of at least one of the housing parts, in particular in such a way that it cannot be detached without destruction from the at least one housing part by mechanical forces. In particular, the polymer film is chemically (i.e. via chemical bonds) bound to the surface of the at least one housing part.

An electrochemical cell is accordingly preferably free of separate sealing components such as film seals and injection-molded seals whose function is taken over by the polymer film.

Preferably, the polymer film, in particular as layer or coating, is arranged between the housing parts and insulates these electrically from one another. In the case of a button cell having a cell cup and a cell lid, the layer or coating is preferably arranged between the outside of the cell lid and the inside of the cell cup (preferably over the entire region of the outer wall of the housing). Preferably, the polymer film is thus firmly joined to the surface of two housing parts.

As mentioned above, the layer thicknesses of the sealing layers or coatings can be set flexibly in a process. The polymer film in an electrochemical cell preferably has an average thickness of from 1 μm to 100 μm, preferably from 1 μm to 50 μm, in particular from 5 μm to 15 μm. These are significantly below the thicknesses known from the prior art for sealing elements for electrochemical cells.

Preferably, at least one part of the cell housing, in particular the cell cup and/or the cell lid, has an edge region which is covered by the polymer film. In this way, the edge region is protected against corrosion, as has been explained above.

As indicated above, the polymer film can, for example, comprise an inorganic-organic copolymer, in particular an ormocer, or an organic polymer, in particular a parylene. The use of inorganic-organic hybrid polymers, in particular of ormocers, and also of parylenes as sealing material for electrochemical cells, in particular for button cells, is likewise encompassed by the present invention. What has been said with regard to these classes of compounds in the description of the process is hereby incorporated by reference at this point.

The abovementioned and further advantages can be derived from the following description of the drawing and the examples. Here, the individual features can be realized either alone or in combination with one another. The examples described are merely for the purposes of illustration and to give a better understanding and are not to be construed as constituting any limitation.

Turning now to the drawing, a cell housing is assembled from a cell cup and a cell lid. Both the cell cup 1 and the cell lid 2 have a bottom (1a and 2a) and a cylindrical wall (1b and 2b) joined thereto. At the open end of the cup and of the lid, the cup edge 1c and the lid edge 2c are marked. To seal the housing, a thin layer of a polymer precursor is applied to the cell cup 1 and the cell lid 2. The cell cup 3 and cell lid 4 provided with the thin layer of the polymer precursor are subsequently assembled, in particular after introduction of electrodes, separator and electrolyte, to form the housing 5. After curing of the polymer precursor, the sealed housing 6 is obtained.

As can readily be seen, the polymer precursor is applied to the cell cup and the cell lid in such a way that it forms a layer (6b) which insulates the parts of the housing from one another in the assembled housing. For this purpose, the polymer precursor is applied to the outside 3c and the inside 3a of the cylindrical wall of the cell cup and to the outside 4c and the inside 4a of the cylindrical wall of the cell lid. In particular, the edge region 3b of the cell cup and the edge region 4b of the cell lid are also coated with the polymer precursor.

### EXAMPLES

Housing lids having an edge bent over in the edge region, as are described in WO 2007/062838, were partly coated with parylene. The outside of the cylindrical section and also the edge region were coated in each case. Coating was carried out by means of a conventional coating apparatus as can be obtained, for example, from SCS Specialty Coating Systems in Indianapolis (Ind., 46278 USA). Both coatings with parylene C (monochloro-substituted) and other types of parylene, in particular with parylene D (dichloro-substituted) and parylene HT (fluorine-modified), were tested successfully. Button cells which easily met the usual requirements for freedom from leaks were obtained in each case. It was able to be shown by microscopic examinations that the sealing polymer film between cell cup and cell lid had a thickness of less than 15 μm.

1. A process for producing an electrochemical cell comprising assembling a cell housing from a plurality of parts, and applying and curing at least one reactive polymer precursor to at least one of the housing parts to seal the housing.

2. The process as claimed in claim 1, wherein the at least one polymer precursor is applied to the at least one housing part such that in the assembled housing it is arranged in the contact region of the housing parts as a layer between the housing parts.

3. The process as claimed in claim 1, wherein the at least one polymer precursor is applied to the at least one housing part such that after curing it forms a layer in the assembled housing which insulates parts of the housing from one another.

4. The process as claimed in claim 1, wherein the at least one polymer precursor is selected so that it has electrically insulating properties in a cured state.

5. The process as claimed in claim 1, wherein the at least one polymer precursor is selected so that it has hydrophobic properties in a cured state.

6. The process as claimed in claim 1, wherein the at least one polymer precursor is selected so that in a cured state it is chemically inert toward aqueous alkaline electrolytes and/or organic electrolytes based on carbonate.

7. The process as claimed in claim 1, wherein the at least one polymer precursor can be cured thermally and/or by radiation.

8. The process as claimed in claim 1, wherein a parylene precursor for an organic polymer is applied as polymer precursor.

9. The process as claimed in claim 1, wherein an ormocer precursor for an inorganic-organic copolymer is applied as polymer precursor.

10. The process as claimed in claim 1, wherein the at least one polymer precursor is cured after assembly of the housing.

11. The process as claimed in claim 1, wherein the cell housing is assembled from metal parts made of nickel-plated steel.

12. The process as claimed in claim 1, wherein the housing is assembled from a cell cup and a cell lid.

13. The process as claimed in claim 12, wherein the at least one polymer precursor is applied to the cell cup and/or the cell lid such that it covers the edge region of the cell cup and/or the cell lid.

14. An electrochemical cell comprising an at least two-part housing made up of a cell cup and a cell lid produced by a process as claimed in claim 1, wherein the housing is sealed by an electrically nonconductive polymer film.

15. The electrochemical cell as claimed in claim 14, wherein the polymer film is a layer or coating on a surface of at least one of the housing parts.

16. The electrochemical cell as claimed in claim 14, wherein the polymer film as a layer or coating is arranged between the housing parts and insulates the parts electrically from one another.

17. The electrochemical cell as claimed in claim 15, wherein the polymer film has an average thickness of from 10 μm to 100 μm.

18. The electrochemical cell as claimed in claim 14, wherein the housing parts have an edge region covered by the polymer film.

19. The electrochemical cell as claimed in claim 14, wherein the polymer film comprises an inorganic-organic copolymer.

20. The electrochemical cell as claimed in claim 14, wherein the polymer film comprises an organic polymer.

21. (canceled)

22. (canceled)
